(19) United States
(12) Patent Application Publication
(10) Pub. No.: US 2010/0044129 A1
(43) Pub. Date: Feb. 25, 2010

(54) HYBRID VEHICLE FORMED BY CONVERTING A CONVENTIONAL IC ENGINE POWERED VEHICLE AND METHOD OF SUCH CONVERSION

(75) Inventor: Ronald Kyle, Akron, OH (US)

Correspondence Address: GIFFORD, KRASS, SPRINKLE,ANDERSON & CITKOWSKI, P.C, PO BOX 7021, TROY, MI, 48007-7021, US

(73) Assignee: Hybrid Electric Conversion Co., LLC, Miami, FL (US)

(21) Appl. No.: 12/553,389

(22) Filed: Sep. 3, 2009

Related U.S. Application Data
(63) Continuation-in-part of application No. 11/181,318, filed on Jul. 14, 2005, now abandoned.
(60) Provisional application No. 60/599,906, filed on Aug. 9, 2004.
(60) Provisional application No. 60/618,881, filed on Oct. 14, 2004.
(60) Provisional application No. 60/626,556, filed on Nov. 10, 2004.
(60) Provisional application No. 60/631,310, filed on Nov. 29, 2004.
(60) Provisional application No. 60/664,043, filed on Mar. 22, 2005.
(60) Provisional application No. 60/664,052, filed on Mar. 22, 2005.
(60) Provisional application No. 60/664,309, filed on Mar. 22, 2005.
(60) Provisional application No. 60/671,567, filed on Apr. 15, 2005.

(51) Int. Cl. B60K 6/48; B23P 23/00

(52) U.S. Cl. 180/65.25; 29/401.1; 180/65.21

(57) ABSTRACT

A method of modifying a conventional internal combustion powered vehicle to hybrid electrical form involving modifying the drive train so that the rotor of a motor generator may be connected to the input of the drive train. This may be accomplished by removing an element and substituting a transfer case having driving inputs from both the engine and motor-generator, or by connecting the rotor of the motor generator to an input to the drive train.

### CROSS-REFERENCE TO RELATED APPLICATIONS

This application is a continuation-in-part of U.S. patent application Ser. No. 11/181,318 filed Jul. 14, 2005, which claims priority of U.S. Provisional Patent Applications 60/599,906 filed Aug. 9, 2004; 60/618,881 filed Oct. 14, 2004; 60/626,556 filed Nov. 10, 2004; 60/631,310 filed Nov. 29, 2004; 60/664,043 filed Mar. 22, 2005; 60/664,052 filed Mar. 22, 2005; 60/664,309 filed Mar. 22, 2005; and 60/671,567 filed Apr. 15, 2005, which are incorporated herein by reference.

### FIELD OF THE INVENTION

This invention relates to automotive vehicles primarily powered by internal combustion engines and, more particularly, to a method of converting such vehicles into hybrid vehicles by adding a motor/generator connected into the drive train to both provide driving power and remove power during regenerative braking to recharge the vehicle battery.

### BACKGROUND OF THE INVENTION

Hybrid vehicles, which utilize both an internal combustion engine and an electric drive motor to power the vehicle, are known to provide important advantages over conventional vehicles, powered solely by internal combustion engines, in terms of fuel economy, emissions, vehicle performance, and the like. The hybrid vehicles achieve improved fuel economy in several ways. First, the electric drives complement the internal combustion engine drives in a fundamental manner since internal combustion engines essentially provide zero torque at start-up and accordingly must idle at fairly high speeds, wasting fuel, and must be connected to the drive wheels of the vehicle through inherently inefficient transmissions, while electric motors provide maximum torque at start-up and can bring a vehicle from a standing stop to an operating speed with high efficiency without the need for a transmission and/or by working in cooperation with the transmission. Similarly, internal combustion engines are very inefficient in high acceleration modes. By starting up the vehicle with an electric motor and providing electric power assist during acceleration, internal combustion engines can be used at primarily relatively constant speeds and power ranges, for which engine operation is much more efficient. Additionally, electric motor/generators can recover power from the reduction in momentum by utilizing the generators for braking and convert this mechanical power into electric power, which can be used to recharge the vehicle's batteries or energy storage system. In some hybrid systems, the internal combustion engine can be turned off during short stop conditions, such as those associated with vehicle traffic signals and stop-and-start driving conditions encountered in heavy traffic. Since the internal combustion engine is not required as the sole driving force to accelerate the vehicle during starting, or when sudden acceleration is required, smaller internal combustion engines may be employed on hybrid vehicles when compared to conventional vehicles, reducing the vehicle weight and further improving fuel efficiency. Therefore, with the use of this invention whenever the vehicle engine is replaced a smaller, more efficient engine could be used. All of these efficiency improvements reduce noxious emissions, which are completely eliminated while the vehicle is powered by the electric driving motor exclusively.

Hybrid powered vehicles generally achieve fuel economies which constitute a 25-40% improvement over conventional internal combustion engine powered vehicles. Since the internal combustion engine will be operating in a more efficient manner for a much greater portion of the time, the reductions in undesirable emissions are likely to be even greater than the reductions in fuel consumption. Emissions of materials suspected of contributing to global warming will also be reduced by similar amounts.

Considering the diminishing reserves of crude oil, the increasing costs of finding new fields, the increasing costs of producing and transporting oil from new fields, and the attendant price increases of petroleum for powering vehicles, the precarious position in which major oil importing countries like the United States, which requires imports of more than 10 million barrels per day of crude oil and more than 2 million barrels per day of other petroleum products, have been placed because of their dependence on these large quantities of petroleum from undependable and/or politically unstable sources, particularly in the Middle East and Africa, it would be extremely advantageous if the existing fleet of petroleum powered vehicles, which consumption of motor gasoline and diesel fuel is more than 80% of the imports of crude oil and other petroleum products, could be converted to hybrid operation.

However, it would be economically irresponsible simply to junk or retire otherwise serviceable, conventional vehicles in favor of new hybrid vehicles. The U.S. has in excess of 230 million vehicles on the road and their average remaining service life has been estimated at 7-9 years, while newer vehicles may have a remaining service life of 12-14 years. Vehicle scrappage rates are expected to continue to decline as the vehicles with the greatest proven durability, light trucks, are selling at rates exceeding 9 million units per year.

As a partial solution to this problem of the significant advantages which would be achieved by substitution of hybrid vehicles for conventional internal combustion engine powered vehicles and the relatively slow conversion that will be achieved if only a percentage of new vehicles are in hybrid form, the present invention is directed at a method of converting existing conventional internal combustion powered vehicles to hybrid form. The conversion is designed to be relatively easily achieved, at a minimum cost both in terms of the conversion labor and the components added during conversion. By invoking methods and apparatus formed in accordance with the present invention, the rate of conversion of the present stock of internal combustion engine powered vehicles into a much more efficient hybrid form would be maximized.

### SUMMARY OF THE INVENTION

Broadly, the present invention relates to a method of retrofitting a conventional internal combustion engine powered vehicle, such as an automobile, a truck, or a tractor for a trailer, to hybrid form. Broadly, these vehicles employ an internal combustion engine to drive the powered wheels of the vehicle, through a drive train, which may incorporate a torque converter, transmission, and/or a differential, and one or more drive shafts connected by universal joints. These elements are typically connected in a serial fashion. The present invention broadly involves the modifying the drive train to provide a motor/alternator, into the drive train so that power from the motor may be added to the driving power applied to the wheels and power may be removed, typically during deceleration and braking, to generate electric power which is used to charge a battery and/or capacitor or other electric power storage system for the system. The motor/generator or motor/alternator also will supply power to and draw power from the energy storage system to facilitate more economic operation of the internal combustion engine.

The modifications of the selected power train element to achieve conversion to hybrid drive may involve removing one of the elements, such as the drive shaft interconnecting the transmission to the differential, with a transfer case which provides a geared connection between the drive train and an auxiliary shaft that may be connected to a motor/generator. This essentially involves interposing the transfer case in serial fashion into the drive line so that the input shaft of the transfer case receives power and outputs it through the output shaft of the transfer case in the same manner as the section of drive shaft as was replaced. Alternatively, the modification may involve attaching a drive element, such as a gear, pulley, chain sprocket or the like, to a section of the drive shaft so that power may be introduced and removed from the drive train or the motor/generator with a driveshaft extending from each end may be interposed in a serial fashion into the drive line in the same manner as the section of drive shaft as was replaced.

In a preferred embodiment of the invention, the element interposed is a transfer case which includes gearing which interconnects the engine driven shaft with another shaft powered by one or more motors forming parts of a motor/generator set. Gearing is provided to accommodate the differences in the optimum internal combustion engine speed and electric motor speed. The transfer case may also incorporate a clutch, preferably electrically and/or hydraulically actuated, which can operate to engage and disengage the vehicle engine from the powered wheels during stops and/or when power from the internal combustion engine is not required. Alternatively, the clutch may be separate from the transfer case.

Alternatively, the power train may be modified by removal of either the clutch connecting the output shaft of the internal combustion engine with a manual transmission, or the torque converter connecting the engine output shaft with an automatic transmission. This connection is replaced with a motor-generator having its stator fixed relative to the engine and its shaft joined to the connection between the engine output shaft and the transmission input. When the motor generator is powered so as to act as a motor, its output shaft drives the transmission input, either solely, in the pure electric mode, or along with power from the engine. When the electric motor is not energized by the power storage unit, its rotor is turned by the engine shaft and it acts as a generator.

In a preferred embodiment of the invention in which the vehicle employs a frame, including a pair of longitudinally extending members disposed on opposite sides of the engine and one or more cross-members for supporting the engine and transmission weight, the vehicle is provided with one or more additional cross-members that support the transfer case and/or the motor/generators, and/or other auxiliary apparatus required for hybrid operation.

A preferred embodiment of the invention also includes an electronic controller. The brake pedal and the accelerator pedal of the engine, actuated by the operator, are connected to position sensors, preferably of the inductive type, which generate electrical outputs proportional to the pedal positions. These signals are provided to the controller, along with a variety of other signals related to the state of operation of the vehicle, such as the engine speed, transmission output shaft speed, and the vehicle speed or wheel speed. The controller constitutes a digital computer programmed to generate electrical output signals which control the engine energization through the ignition system and/or the fuel system, engine speed through the fuel injector system, the clutch which can connect or disconnect the engine from the driving wheels, the electric motor speed and the interconnection between the motor/generator and the electric powered storage system.

The operator may switch the controller between modes appropriate to stop/start driving in traffic or continuous operation at cruising speeds typical of long-distance hauls or trips. Alternatively, the controller may automatically sense the appropriate control mode and control its own switching.

The inventive system may incorporate the addition of the vehicle highway routes into the controller to permit the adaptation of the vehicle energy management to the highway features such as the up and down grades, stopping points, and the like. Using this highway information, the controller could use that amount of power from the energy storage system prior to the beginning of a downgrade that would provide for the maximum recovery of energy to the energy storage system from regenerative braking while the vehicle is traveling on the downgrade and similar programming can be used to maximize energy recovery and use for other known highway features.

The system is capable of operating for some distance under electric motor power while the internal combustion engine is shut down or disengaged. An electric powered pump is provided for generating hydraulic or air braking pressure, air conditioner pressure, power steering pressure, engine and hybrid component cooling equipment, and the like during these times and at other times when the engine is shut off, such as in stop-and-go traffic, during periods of waiting, or during rest periods, especially in the case of trucks. In addition, energy from the energy storage could be use to operate other electrically driven equipment such as phones, computers, refrigerators, ovens and the like, especially in the case of trucks and recreational vehicles. This invention could also supply electrical energy from the energy storage system to power the refrigeration compressor on refrigerated trailers and/or other systems such as hydraulics, winches, screws, and the like on trucks for dumping, compacting, pumping, mixing, and/or other powered actions that could be driven or operated by electric motors or power. The energy storage system could be used to provide power for a campsite or in emergencies for powering home appliances and like equipment during a blackout.

The inventive system may incorporate one or more radial and/or axial gas turbines that would be driven by the vehicle exhaust and such turbine will drive a secondary generator and/or alternator to provide additional charging power for the electric power storage system. Alternatively a portion or all of the power generated by the exhaust gas turbine may be directed directly to the electric propulsion or accessory drive motors. Typically turbochargers are used only whenever the vehicle requires more power and the engine requires more air/oxygen to provide that power. If too much air pressure or boost is provided the engine can be damaged, and if the turbocharger rotational speed is too great it will damage itself. The turbocharger uses only the amount of power from the exhaust that is required for the gas turbine to drive the air compressor or supercharger section whenever more power is required from the engine and as such only operates at partial power output most of the time. A limitation is that when the turbocharger is needed, some time is required before it can speed up to provide the desired boost.

Devices formed in accordance with the present invention also preferably incorporate a switch for controlling energization of the heater to allow the device to blow unheated air, in the manner of a ventilation fan. They may also incorporate adjustable vents at the air output so the air flow may be directed to allow the heating or cooling of body parts which might otherwise be awkward to ventilate.

In still another embodiment of the invention, the torque converter may be retained in the conventional drive train and a radial flux motor-generator be supported radially outboard of the torque converter with its rotor powered through a connection to the rotatable converter housing.

This invention provides for the maximum extraction of power from the exhaust gases by a radial gas turbine similar to that used on the turbocharger or by an axial, preferably a multi-stage, gas turbine. Alternatively two or more radial turbines could be used in series each sized to match the temperatures and flow rates of the exhaust gases at their specific locations. The turbine nearest to the exhaust manifold would be designed for the expansion of the exhaust gas at that point and the next radial turbine would be matched to the lower temperature and flow rates of the gases exiting from the first turbine. These turbines can operate at optimum speed and power output which will be controlled by the generator loading. Depending on the size and type of gas turbine this system could provide an additional 10-30% improvement in fuel economy with the associated reductions in undesirable emissions.

In vehicles currently equipped with turbochargers, the power boost typically added by using the turbochargers may be substituted for by drawing power from the energy storage system. An advantage would be that this electric power will be available instantaneously. Alternatively, if desired, a separate air compressor such as a Roots or Lysholm type supercharger powered by an electric motor can be added to provide increased air flow for the engine as would have been provided by the turbocharger. Such a supercharger relative to the turbocharger system would use less power, provide certain quantities and pressures of air to the engine, operate at low speeds, and require less maintenance. The exhaust turbine can be located downstream of the turbocharger.

In an alternative embodiment to the invention, which will be discussed in detail in the following detailed description of the invention, rather than replacing a component of the drive train to allow the introduction and removal of drive power from the motor/generator, the conventional drive train is modified by fixing a drive element to the exterior of the drive shaft which allows a mechanical connection, such as a drive gear, belt pulley or chain sprocket.

This inventive design also provides for the ready adaptation of additional vehicle energy efficiencies such as the recovery of waste energy from other vehicle sources and/or energy imported to the vehicle from external sources such as home and other connections to import power from electric utilities to the electric storage system and/or directly to the electric motors.

### BRIEF DESCRIPTION OF THE DRAWINGS

Other objects, applications and advantages of the present invention will be made apparent by the following detailed description of several embodiments of the invention. The description makes reference to the accompanying drawings in which:

FIG. 1 is a schematic drawing of a drive train of a conventional internal combustion engine powered vehicle converted to a hybrid drive in accordance with a preferred embodiment of my invention;

FIGS. 2A-E are schematic diagrams of the mechanical and electric power flows in the converted vehicle of FIG. 1 during different driving modes;

FIG. 3 is a schematic diagram of an embodiment of my invention wherein conversion to hybrid drive is achieved by the addition of a drive element to a drive shaft in the drive train of an IC engine powered vehicle;

FIG. 4 is a schematic diagram of a turbocharger for an IC engine powered by an exhaust gas driven turbine;

FIG. 5 is a schematic drawing of an alternative embodiment of the invention in which the torque converter of a conventional IC powered vehicle is replaced by a radial flux motor-generator set;

FIG. 6 is a schematic drawing of a variation of the vehicle drive drain of FIG. 5 in which the torque converter is replaced by an axial flux motor-generator; and

FIG. 7 is a schematic diagram of an embodiment in which the original drive train is retained and a radial flux motor-generator having its rotor powered by the rotation of the torque converter housing is added.

### DETAILED DESCRIPTION OF THE INVENTION

The present invention is applicable to any wheeled vehicle powered by an internal combustion engine, including automobiles, trucks, tractors for trailers, and the like. The vehicles may either be two-wheel drive or four-wheel drive in which both the forward wheels and the rear wheels are powered. These vehicles employ an internal combustion engine, typically driving through a torque converter and/or a transmission into a drive shaft connected to a differential which drives the two wheels. In the case of a four-wheel drive, a transfer case is typically interposed between the transmission and the drive shaft to power the front wheel differential which powers the front drive axles.

The method of the present invention broadly involves modifying one of these drive elements of a conventional vehicle by either removing one of the drive train elements and interposing a modified element in the drive train or modifying a drive train element to allow mechanical connection of an electric motor, and preferably a motor/generator, into the drive train so that its mechanical power may be used to provide driving power to the wheels of the vehicle and, in the case of a motor/generator, power may be removed from the drive train to drive the generator and recharge the electric power storage system of the vehicle.

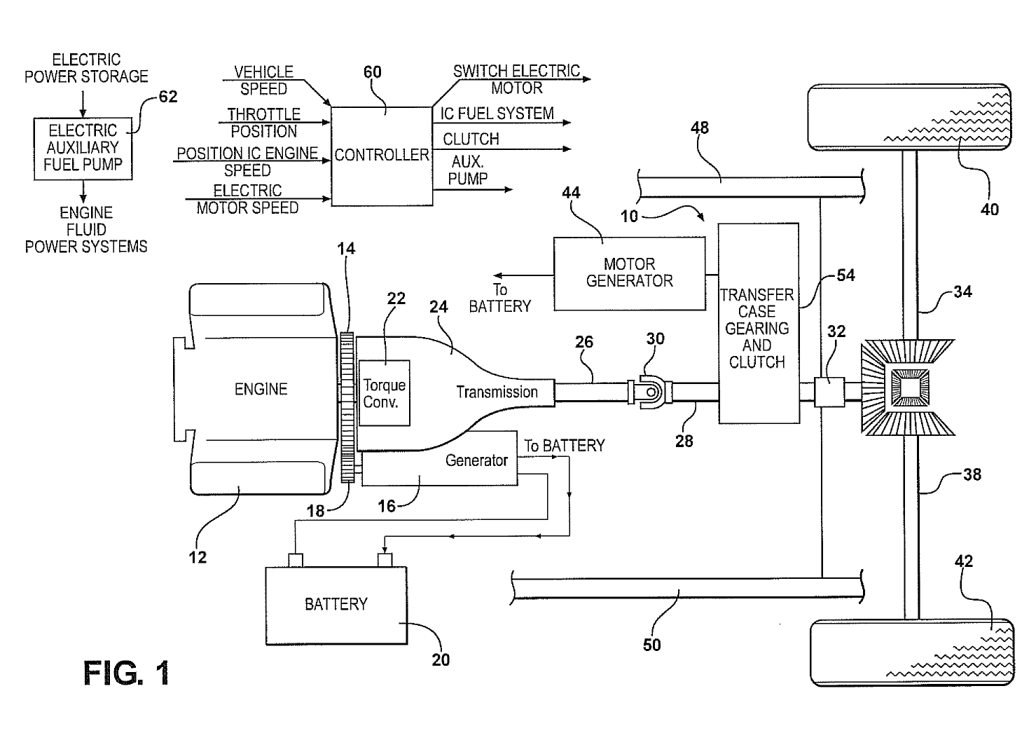

FIG. 1 is a schematic diagram of a conventional rear drive vehicle converted into a hybrid vehicle by the insertion of a transfer case 10 into the drive train and the addition of auxiliary elements necessary to the conversion formed in accordance with a preferred embodiment of my invention.

The conventional vehicle to be converted is powered by an internal combustion engine 12 which constitutes the sole power source for the vehicle to be converted. This engine may be gasoline or diesel, or powered by an unconventional fuel. The engine 12 conventionally incorporates accelerator and brake pedals (not shown) and provides its output to a flywheel 14. In some configurations the flywheel may be connected to a generator or alternator 16 through gearing 18 to supply charging power to an electric power storage system 20, typically an electric battery and/or directly to the driving motor/generator 44. The mechanical output of the engine, through the flywheel 14, may be connected to a torque converter 22 and/or a transmission 24. Alternatively a friction clutch (not shown) may be used in place of the torque converter. This allows the engine 12 to develop sufficient torque to start the vehicle from a stop, since an internal combustion engine typically has no torque at zero speed. The transmission 24 also allows the engine speed to be maintained within an efficient range through varying speeds of the vehicle. The output of the torque converter 22 and/or transmission 24 provided to a drive shaft 26 typically including a fixed portion and an adjustable portion 28 connected by universal joints 30 and 32. In the unconverted vehicle, the drive shaft 28 is continuous between the joints 30 and 32, but in the converted vehicle, the drive train may be interrupted by the transfer case 10. In both the conventional and converted vehicles the drive shaft powers a differential 34 which connects through two powered axles 36 and 38 to the rear driving wheels of the vehicle 40 and 42.

There may be a universal joint at the output shaft of the transmission 30. Typically the shaft between this joint and joint 32 is fixed in length and position. Also, there may be a second differential with powered axles which is driven by a driveline connected from an output shaft at the rear of the front differential to the input shaft of the rear differential.

In the system of the present invention, a conventional vehicle as thus described is converted into a hybrid vehicle by providing a mechanical connection between some element of the drive train and an auxiliary motor/generator 44 and certain auxiliary components and systems which will be subsequently described. In the case of the system of FIG. 1, this modification is achieved by interposing a transfer case into the drive shaft 28, by effectively splitting the drive shaft into two parts and making a driving connection between the driving end of the split drive shaft and one input of the transfer case 10 and providing an output connection between the output of the transfer case 10 and the rear end of the drive train. From a mechanical standpoint, arrangements to achieve this mechanical connection are well within the skill of an experienced automotive mechanic. Alternative manners of modifying the drive train to incorporate mechanical connections for an electric motor will be described in subsequent drawings.

The transfer case 10 and the motor/generator 44 are preferably supported on an auxiliary cross-member 46 interposed between two of the longitudinal frame members 48 and 50 of the vehicle, or comparable elements of a unitary body frame, if that arrangement is employed by the conventional vehicle. A conventional frame system will have certain cross-members for supporting the engine, the transmission, and the like; and the addition of one or more cross-members to support the electric motor and transfer case are the only structural changes needed to implement the conversion of FIG. 1.

The transfer case 10 preferably incorporates a second input shaft 52 in addition to the input shaft which accepts the drive line element 28, and an output shaft 54 connected to the drive line elements fitting the rear wheels. The transfer case preferably incorporates gearing to accommodate differences in the normal shaft speeds between the inputs 52 and 28 and a clutch which can disconnect the input 28 from the output shaft 54. This clutch allows the internal combustion engine to be turned off at various points in the operational cycle of the vehicle, such as when the vehicle is stopped during traffic. Since the electric motor 44 achieves maximum torque at starting speeds, it is capable of independently starting the vehicle, and the internal combustion engine 12 can be restarted after the vehicle has attained a predetermined speed.

The motor/generator 44 is electrically connected to the battery 20 or other electrical power storage system for the vehicle which may include other auxiliary electric storage elements, such as ultra-capacitors. In converting the conventional vehicle to hybrid form, the original battery must be supplanted by a battery of a much larger power storage and output capacities. The storage system 20 provides power for the motor 44 during those portions of the driving cycle in which electric power is applied to the driving wheels, either alone or in connection with driving power from the engine 12. The storage system 20 may be recharged both by the generator 16 driven by the internal combustion engine 12 and by the generator portion of the unit 44 when the electric motor 44 is deenergized during braking or deceleration of the vehicle, to regeneratively convert mechanical power associated with the momentum of the vehicle into electric power and simultaneously assist in the braking of the vehicle. Alternatively for some configurations the generator 16 and the associated connections will be excluded.

The generator typically is used whenever a torque converter is used. Its function is to provide power directly to the motors and the storage system and also to act as a motor to restart the IC engine. In vehicles with torque converters by using either the engine starter or a separate motor/generator sized to run the accessories attached to the serpentine belt, no separate generator is required. In this case an electric/hydraulic clutch on the crankshaft pulley may be engaged to restart the engine after a stop.

To convert the conventional internal combustion powered vehicle into a hybrid vehicle, a controller 16 must also be provided. The controller is essentially a specially programmed digital computer. The controller receives a variety of input signals representative of the operational status of the vehicle. These may include throttle position and brake pedal position signals generated by sensors associated with the brake and throttle pedals of the vehicle (not shown). They may also include vehicle speed signal, internal combustion engine speed signal, and an electric motor speed signal, as well as other useful signals. Vehicle highway routes including highway features such as terrain, stopping points and the like may also be added to the controller/computer and/or this data may be provided and/or in conjunction with other relevant data from a GPS satellite and/or other providers of such information. The controller provides control outputs for various systems of the vehicle, including a switch control signal to energize and deenergize the motor portion of the motor/generator 44; a speed control for the vehicle which may constitute the driving signal for the fuel injection system of the vehicle; a control for the clutch contained in the transfer case 10 to disconnect the engine 12 from the driving train during stopping; and a control for an auxiliary pump 62 powered by the electric storage system 20 and providing hydraulic power to various auxiliary engine systems, such as the braking system, the air conditioning pump, and the like, while the vehicle is in operation with the internal combustion engine deenergized.

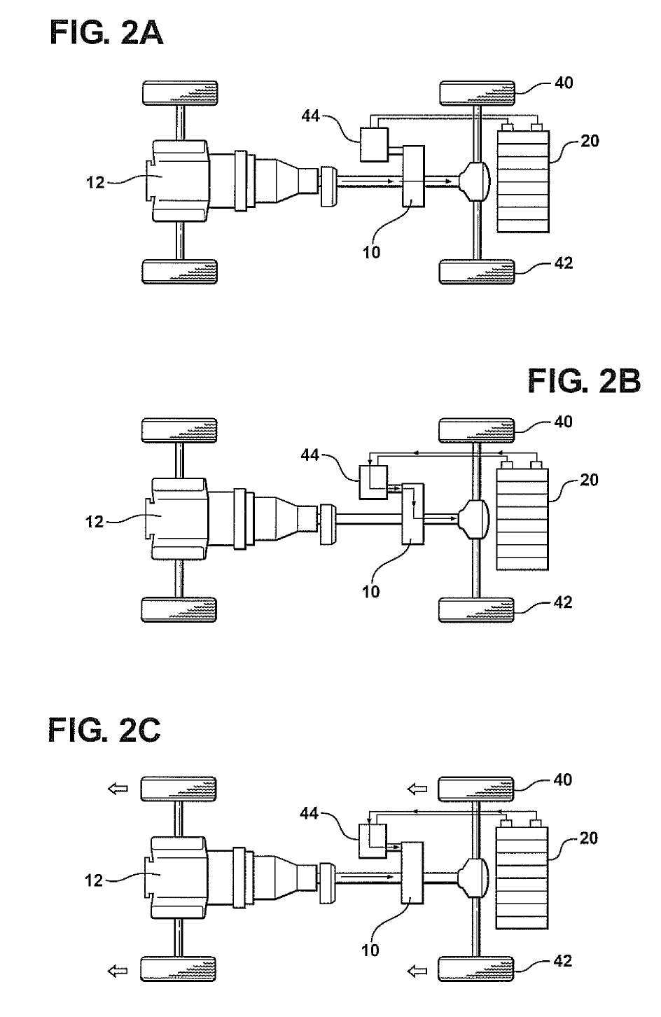

FIGS. 2A-2E schematically illustrate the power flows during five different driving modes for the hybrid vehicle of FIG. 1.

FIG. 2A illustrates the power flow during conventional driving at a relatively steady state of cruising speeds in which the internal combustion alone powers the hybrid vehicle. The engine 12 provides power to the transfer case which feeds it to the rear wheels 40 and 42, and the battery or electric power storage unit solely provides conventional power for the internal combustion engine, such as the ignition.

In converting a conventional vehicle to hybrid form, the original battery and/or electrical system on the vehicle may be preserved. If a motor/generator is employed in place of the alternator, it can be powered from the high-powered energy storage and an inverter may be used to recharge the high powered energy system plus the original vehicle battery.

FIG. 2A represents the power flow during start-up and low speed driving in which the internal combustion engine 12 is deenergized by virtual signals from the controller 60 and the electric motor 44 is energized to provide the sole driving power for the vehicle. In FIG. 2C, the vehicle is accelerated after the internal combustion engine has been energized and the driving power is applied to the wheels 40 and 42 through both the internal combustion engine 12 and the electric motor 44. FIG. 2D illustrates the power flow in driving at a constant speed in which the internal combustion engine is charged primarily by the generator 16 and there is no power flow from the motor/generator 44. FIG. 2E illustrates operation during braking or deceleration of the vehicle in which the wheels drive the motor/generator 22 via the transfer case 10 to provide recharging power to the battery 20.

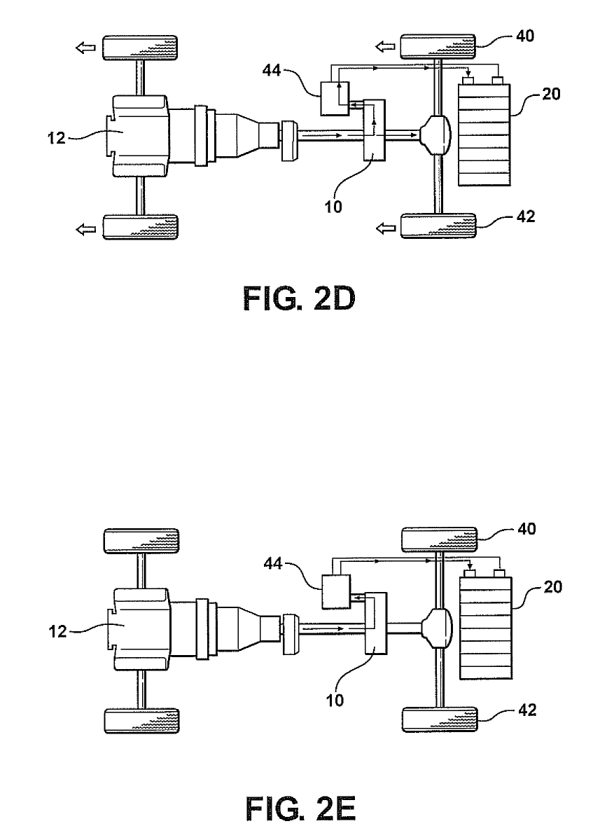

Rather than removing and modifying one of the elements of the drive train, the modification of a conventional internal combustion powered engine into a hybrid engine may simply take the form of adding a power connection to the drive train of a conventional vehicle. One form of this connection is schematically illustrated in FIG. 3. Power from the transmission of the vehicle 24 (which may alternatively be a torque converter or the like) is introduced into a drive shaft 70. A coupling 72 is suitably affixed to the exterior of the drive shaft by welding or the like. The coupling may be a gear, a sprocket for a chain drive, a belt drive pulley or a similar mechanical device. A motor/generator 74 is coupled to the drive element 72 by gearing 76 or other appropriate connection. Mechanical power generated while the motor portion of the motor/generator 74 is energized is applied to the drive shaft through the connection 72-76 and adds to the mechanical driving force for the wheels of the vehicle. During periods in which the motor portion of the motor/generator 74 is not energized and the generator is connected to a power storage device 78, power is removed from the drive shaft 76, applying an effective braking to the vehicle wheels, and the generator portion of the motor/generator 74 applies recharging power to the storage unit 78

Other appropriate subassemblies of the type generally illustrated in FIG. 1, such as the controller 60, the pump 62, and the motor/generator 44, may be supported on an added cross-member 38 supported on the frame or otherwise on the vehicle.

The auxiliary mechanical connection required to apply and remove supplementary power to the drive train required in the modification covered by the present invention could be implemented at other locations, such as the flywheel of the vehicle, the transfer case in front-wheel drives and four-wheel drives, the differential, the axle shafts in both front-wheel and rear-wheel drives, etc. Alternatively wheel-hub motor/generators with or without a transfer case, gears, belts, pulleys, and the like may be added to the wheels in any drive system.

In all these situations, the power train could either be interrupted by the addition of another serial element or the power connection could be applied to an element added to the exterior of the drive train in the manner of FIG. 3.

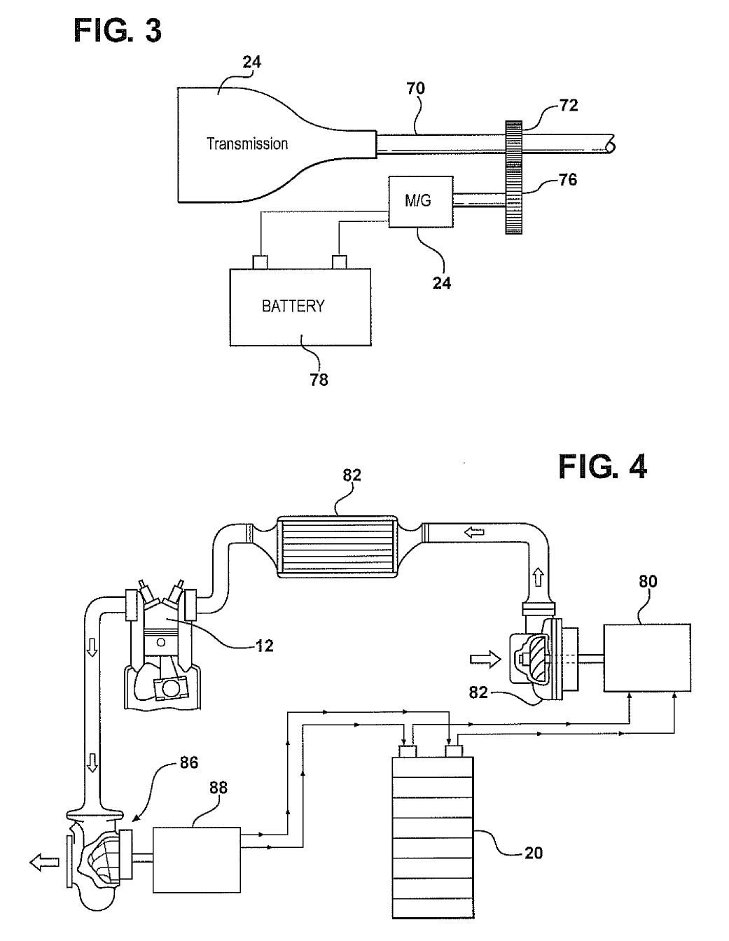

In an alternative embodiment of the invention, illustrated in FIG. 4, the conversion of a conventional internal combustion engine powered vehicle to hybrid form includes the provision of radial and/or axial gas turbines to extract the maximum amount of energy from the exhaust gases and use that energy to drive a generator which would provide this power to the electrical energy storage system. Such turbines would be operated at capacity or to recover the energy available under various engine operating conditions. The energy boost typically provided by the engine turbocharger combination could be provided instead by drawing power from the electrical energy storage system to power the electric motors. Such operation would recover much more energy from the exhaust gases and use that energy more efficiently. In addition it would greatly simplify the engine air intake system.

This alternative embodiment, for those vehicles requiring it, also could provide for a supercharger for the internal combustion engine powered by a compressor driven off the electric power storage system and/or a turbine powered by the exhaust gases of the vehicle driving an electrical generator which may provide its power to the electric power storage system or to the electric motor which drives the compressor for the supercharger.

Referring to FIG. 4, an auxiliary electric motor 80 may be connected to the electric power storage system and, under control of the controller (not shown), may drive an air compressor 82. The compressed air output of the compressor 82 is provided to an air cooler 84 and then to the input manifold of the internal combustion engine 12. The exhaust gases from the exhaust manifold of the internal combustion engine 12 are provided to an axial turbine 86 which drives an auxiliary electrical generator 88. The power from the electrical generator may be provided to the electrical energy storage system 20 or directly to the motor 80 which drives the compressor 82. Under control of the controller 44, the air pressure boost to the internal combustion engine provided by the compressor 82 can be tailored to match engine operating conditions, whether it be starting from a standing stop, quick or moderate acceleration, constant speed on a level highway, stop-and-go conditions, mountainous or hilly conditions, high or low altitude, or any other situation. The supercharger compressor 82, since it is driven by electric motor 80 that can draw a portion or all of its power needs from the energy storage system 20, can provide boost immediately at, and/or even before, engine start-up and can maintain precise boost levels and/or charge/air flow rates at all engine speeds. There is no waiting for the engine to start or warm up, nor are there any other delays due to engine-exhaust turbine lag. The charge-air cooler 84 is a heat exchanger which cools the air from the compressor 82 to pack more of it into the cylinder and helps control emissions by lowering combustion temperatures. If desired, water, a water-alcohol mixture, or other suitable fluids may be introduced into the charged air at the compressor intake or anywhere in the charged-air system, to further lower the combustion temperature for lower emissions and improved engine performance. The supercharger compressor 82 may be of the Roots or Lysholm type which relative to the current turbocharger system use less power, provide certain quantities and pressures of air to the engine, operate at low speeds, and require less maintenance. The addition of equipment of the type illustrated in FIG. 4 to a conventional vehicle would substantially improve fuel mileage.

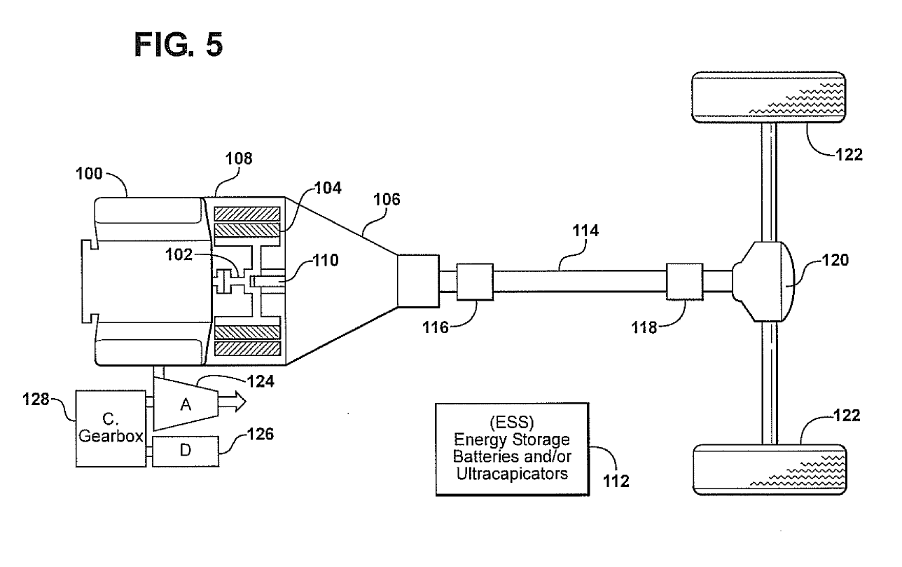

FIG. 5 is a schematic diagram of a conventional IC engine powered vehicle drive train, converted into a hybrid version which uses stored electrical energy as well as the energy of the engine. A conventional internal combustion engine 100 has an output shaft 102 that is provided to a conventional transmission 104 as well as to the rotor 106 of a radial flux motor-generator generally indicated at 108. In the conventional vehicle the space occupied by the motor-generator 108 would have contained a conventional torque converter or clutch, as the case may be, and the output shaft would be provided to the transmission 104. The rotor 106 is connected to the input shaft 110 for the transmission 104. The internal engine drive shaft 102 provides power to the input shaft 110 at the transmission and also drives the rotor 106 of the motor-generator. When the engine 100 is operating, the unit 108 acts as a generator and provides electric power to an energy storage unit 112 which normally constitutes batteries and may include ultra capacitors. The exhaust of the engine 100 is passed through an exhaust turbine 124 which drives an electrical generator 126 through a gearbox 128. The output of the generator 126 is also provided to the energy storage unit 112.

The space occupied by the motor-generator 108 was created by moving a torque converter from the space between the opposed sides of the internal combustion engine 100 and the transmission 104. This, plus the addition of the exhaust turbine 124 and its associated components, is the only substantial mechanical alteration required to convert a conventional vehicle to hybrid form, and can be performed even by relatively untrained mechanics. Like the other embodiments, power to the electric motor may be derived from the energy storage unit 112 or directly from the generator 126.

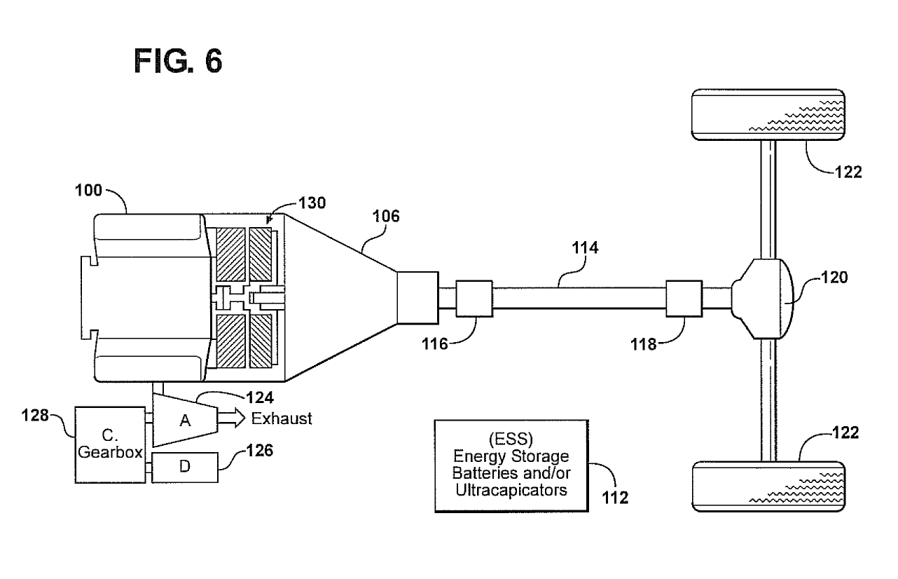

FIG. 6 schematically illustrates a variation on the hybridized vehicle of FIG. 5 employing an axial flow motor-generator, generally indicated at 130 in the space between the internal combustion engine 100 and the transmission 104, which was originally occupied in an unconverted vehicle by a torque converter. The operations of the systems of FIGS. 5 and 6 are otherwise identical.

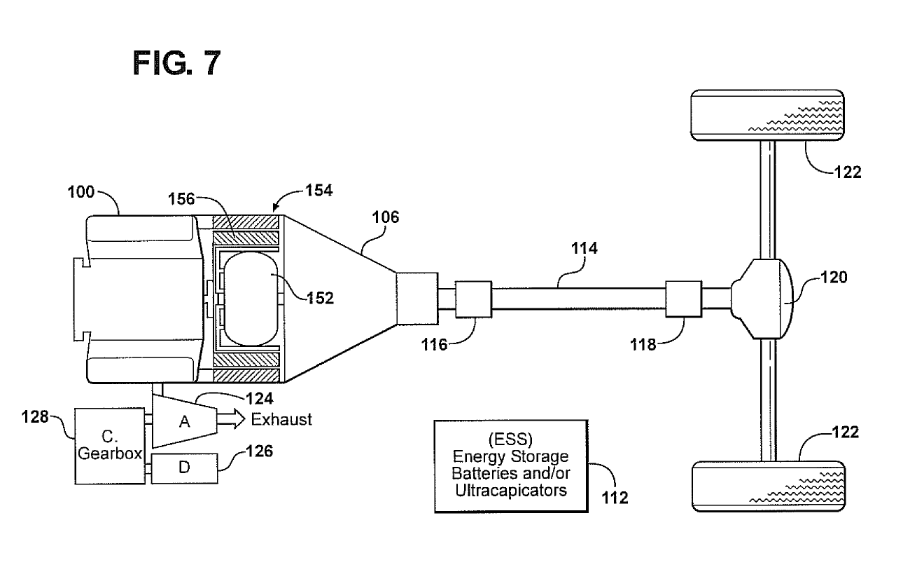

Another variation of the systems of FIGS. 5 and 6 is illustrated in FIG. 7 wherein a torque converter 152 is retained between the internal combustion engine 100 and the transmission 104, in the space occupied by a conventional torque converter in unconverted vehicles. A radial flux motor-generator generally indicated at 154 is supported radially outboard of the torque converter 152 and has its rotor 156 connected to and powered by the rotatable housing of the torque converter 152. Alternatively, an axial-flux motor-generator could be installed with a relatively thin torque converter.

The torque converter 152 and the radial flux motor-generator 154 may be provided as a connected package for insertion into the hybrid vehicle.

### Vehicle Operation after Conversion to a Hybrid-Electric Form

Starting from a Parked Position:

Starting from a parked position, upon the driver's command for the vehicle to move forward, the transmission 104 will be shifted into drive and the vehicle will be powered by the motor-generator acting as a motor and using power from the storage system 112. The vehicle will be accelerated by electric power and will use electric power exclusively until a certain minimum speed is achieved so that the power from the engine 100 can be combined smoothly with power from the motor-generator to power the vehicle.

To move in reverse, the driver will select “reverse” and the vehicle while in reverse will be powered only by the motor-generator using power from the storage system 112. When the driver then selects “forward”, the operation will proceed as described for starting from a parked position under the first paragraph of this section.

When the storage system 112 is discharged to a certain capacity level, the engine 100 will be started. The motor-generator then becomes a generator. The engine 100 will provide motive power for the vehicle. The engine 100 will be operated at the speed (rpm) respective to the vehicle operation as called for by the operator. The engine 100 power level will be continuously controlled to the level that provides for the most efficient operation of the engine 100 at that rpm. The engine 100 power output above that required to propel the vehicle in a normal manner will be sent to the motor-generator, which will use that power to generate electric power that will be used to recharge the storage system 112.

When the storage system 112 is charged to a certain capacity level, fuel flow and/or ignition to the engine 100 will be stopped and the vehicle will be powered by the motor-generator acting as a motor and using power from the storage system 112 as described above in this section. The cycle continues.

### When the Vehicle is Stopped:

During normal operation the vehicle will be stopped by using the motor-generator for regenerative braking and, if needed, the conventional friction braking system will be used as well. The power generated from the regenerative braking will be sent to the storage system 112. For heavier vehicles, resistance rods can be used to assist the regenerative braking and minimize the use of the conventional friction brakes.

When the vehicle comes to a stop, the motor-generator will stop instantaneously and the transmission will be shifted into neutral. While the vehicle is stopped, the motor-generator will provide power to the accessories (power steering, power brakes, air conditioning, alternator, engine 100 cooling, etc.) through the engine 100 by operating it at the minimum rpm required to power the accessories. The engine 100 throttle can be opened completely and/or other similar methods may be used to reduce throttling losses during this operation.

When the brake is released, the motor-generator will stop instantaneously, the transmission will be shifted into drive, and the vehicle operation will continue as described under the “Starting from a parked position” section above.

Highway Driving with Motor-Generator Assistance:

During normal highway driving the transmission shift points can be coordinated with short periods of supplemental power and regenerative braking supplied by the motor-generator to maintain the engine 100 at its most efficient operation for these conditions. If the vehicle is operating on power solely from the motor-generator and more power is needed, the engine 100 can be restarted to provide supplemental power and braking from the motor-generator to maintain efficient operation. For example, this would probably be a reasonable operating mode over mountainous terrain.

### Stop-and-go Driving:

During prolonged periods of stop-and-go driving, an unusual amount of battery capacity may be used to power the accessories during lengthy periods when there is no movement, which could cause the storage system 112 to drop to a low level of capacity. In such cases, the engine 100 would be started to bring the storage system 112 up to capacity. If the traffic is moving very slowly, the engine 100 could be stopped so that the motor-generator could power the vehicle for the slow short movements typical of stop-and-go operations until the storage system 112 can be recharged fully. The driver could put the vehicle into Stop-and-Go mode or the control system could be programmed to sense the stop-and-go operations and do that automatically.

### Turbine Option:

The turbine 124 recovers power from the engine 100 exhaust and uses it to drive a generator, which will supply additional electric power that will be directed to the motor-generator and/or the engine 100 as relevant. Adding one or more turbines 124 in series or parallel could significantly increase the energy recovery from the exhaust. These configurations and operations have been covered in a previous patent application.

### Other Conditions:

If the vehicle has been stationary for a long period of time so that the storage system 112 reaches its minimum target capacity, the engine 100 will restart and the motor-generator will generate power as required to operate the vehicle systems and recharge the storage system 112.

1. The method of converting an internal combustion engine powered vehicle having a drive train comprising a plurality of the serial elements, including a transmission, into a hybrid vehicle, comprising:
removing an element of the drive train connecting the output of the internal combustion engine to the input of the transmission;
providing an electric motor having a rotor and stator disposed in the area previously occupied by the removed element, the rotor of the electric motor being connected to the input of the transmission;
providing a switchable connection between said electric motor and an electric power storage system;
providing an electronic controller operatively connected to said internal combustion engine aid said switchable connection to said electric motor, in order to control the state of energization of said internal combustion engine and said electric motor;
whereby the electric motor may be connected to the electric power storage system to provide driving power to said vehicle through said drive train.

2. The method of claim 1 in which the element of the drive train removed is a torque converter.

3. The method of claim 1 in which the element of the drive train removed is a clutch.

4. The method of claim 1 in which the electric motor has its stator fixed relative to the internal combustion engine.

5. The method of claim 4 in which the electric motor has its rotor fixed relative to the transmission input shaft and the engine output shaft.

6. The method of claim 1 further comprising providing a turbine powered by the exhaust of the internal combustion engine, the turbine output being drivingly connected to a generator which provides electrical power to the electric motor and the electrical power storage system.

7. The method of converting an IC engine powered vehicle of claim 1, wherein said electric motor is of the alternating current variety, further comprising the step of providing an inverter connected from the source of electric power to the electric motor.

8. The method of converting an internal combustion engine of claim 1, further including providing a rectifier operative to receive input from the generator and provide output to the electric storage system during braking of the vehicle.

9. The method of converting an internal combustion engine of claim 1, further including providing a rectifier operative to receive input from the generator and provide output to the electric storage system.

10. The method of converting an internal combustion engine powered vehicle into a hybrid vehicle of claim 1, wherein said sensors coupled to the controller include a brake position sensor and a throttle position sensor and a vehicle speed sensor.

11. A method of converting an internal combustion engine powered vehicle into a hybrid vehicle of claim 1, further including a forward pump powered by the electric storage system for maintaining braking pressure at such time as the controller deenergizes the internal combustion engine.

12. The method of converting an internal combustion engine powered vehicle into a hybrid vehicle of claim 1, further including a turbine powered by the vehicle exhaust having its mechanical output connected to a generator which has its output connected to the electric storage system.

13. The method of converting an internal combustion engine powered vehicle into a hybrid vehicle of claim 1, wherein the controller is operative to perform the following functions: (1) control internal combustion engine speed, (2) control internal combustion energization state, (3) control electric motor speed.

14. A hybrid powered vehicle comprising:
an internal combustion engine;
a drive train comprising a plurality of serial elements connecting the output of the internal combustion engine to the driving wheels of the vehicle;
an auxiliary power connection to one of said serial elements allowing the introduction of mechanical power derived from an auxiliary motor power element into the drive train and the removal of mechanical power from said drive train;
a motor/generator having a mechanical connection to said auxiliary power connection to allow mechanical power from the motor to be introduced into the drive train to allow mechanical power from said drive train to drive the generator;
an electric storage system for the internal combustion engine;
a switchable connection between said electric motor and said electric storage system; and
an electronic controller operative to sense vehicle conditions and operative to control the state of said internal combustion engine and the motor/generator system to control the operation of the vehicle.

15. The hybrid vehicle of claim 14, in which the auxiliary power connection comprises a drive element connected to the exterior of one of the elements of the drive train.

16. The hybrid vehicle of claim 14, wherein the auxiliary power connection comprises a drive element connected as a serial element in said drive train, providing a driving input from elements of the drive train connected to the engine, and a driving output for elements of the drive train connected to the wheels of the vehicle and a connection to the mechanical output of the motor/generator.

17. The hybrid vehicle of claim 16, including gearing interconnecting the mechanical output of the motor/generator through the auxiliary power connection.

18. The hybrid vehicle of claim 17, further including clutch means for selectively engaging the auxiliary power connection with the elements of the drive train connected to the internal combustion engine.

19. The hybrid vehicle of claim 18, including means powered by said controller for controlling the state of the clutch means.

20. The method of converting an internal combustion engine powered vehicle having a drive train comprising a plurality of serial elements connected between the engine and the wheels of the engine into a hybrid vehicle, comprising:
inserting a transfer case as a serial element in said drive train, said transfer case including an input shaft connected to those drive train elements connected to the internal combustion engine and, an output shaft connected to those drive train elements connected to the driving wheels of the vehicle, a clutch for selectively engaging and disengaging said input shaft to said output shaft, and an auxiliary power shaft connected to said output shaft;
connecting a motor/generator shaft to said auxiliary shaft;
providing a high-energy electric power storage system connected to the engine;
providing a switching connection between the electrical connection of the motor/generator and the electrical storage system;
providing an electronic controller having inputs that are functions of the brake and accelerator pedal positions of the internal combustion engine, the internal combustion engine speed and vehicle speed and having outputs drivingly connected through the switching system between the motor/generator and the power storage source, internal combustion engine, and the clutch; and
providing an auxiliary fluid pump powered by the electric storage system for providing fluid power to a vehicle braking system at such time as the clutch is deenergized.

21. The method of converting an internal combustion engine powered vehicle into a hybrid vehicle, the vehicle having a drive train comprising a plurality of serial elements interconnecting the mechanical output of the internal combustion engine to the drive wheels of the vehicle, and having a frame, including spaced pair of longitudinal elements disposed on opposite sides of the engine.

22. The method of claim 21 comprising:
modifying one of said serial elements into a form which provides a connection for applying mechanical power from an electric motor into the drive train;
providing a cross-member extending between said longitudinal elements, supporting a motor/generator on said cross-member;
connecting the mechanical output of the motor/generator into said connection for applying mechanical power into the drive train;
providing an electric power storage system;
providing a switchable connection between the electrical connection of the motor/generator and the electric power storage system; and
providing a controller operative to receive inputs as a function of the brake and accelerator pedal positions of the vehicle, the engine speed and the vehicle speed, and to provide outputs of the internal combustion engine and the motor/generator;
whereby the motor/generator may be connected to the electric storage system to provide driving power to said vehicle to supplement driving power provided by said internal combustion engine through said drive train;
and power from the drive train may be used to power the motor/generator to fit into the electric power storage source during braking of the vehicle.

23. The method of claim 20 wherein the controller is provided with information related to a route to be traversed by said vehicle, including elevations along the route, and the controller uses this information to control the mode of operation of the hybrid vehicle along that route.
